(19) United States
(12) Patent Application Publication
(10) Pub. No.: US 2012/0043111 A1
(43) Pub. Date: Feb. 23, 2012

(54) LONG BODY UNIT WITH SLIDER

(75) Inventors: Shunsuke Shiomi, Tokyo (JP); Keitaro Fujiwara, Tokyo (JP)

(73) Assignee: Sony Corporation, Tokyo (JP)

(21) Appl. No.: 13/208,920

(22) Filed: Aug. 12, 2011

(30) Foreign Application Priority Data
Aug. 19, 2010 (JP) 2010-184357

(51) Int. Cl. H01B 7/00

(52) U.S. Cl. 174/135

(57) ABSTRACT

The present disclosure provides a long body unit with slider, including, a first long body, a second long body, and a slider provided for the first long body and the second long body, the slider including, a connection section by which the first long body and the second long body are clamped and are thereby united together, a separation section by which the first long body and the second long body united together by the connection section are separated from each other, and a restriction section by which the first long body and/or the second long body is restricted in rotation about an axial direction.

### BACKGROUND

The present technology relates to a long body unit with slider, particularly to a long body unit with slider in which a plurality of long bodies can be united together and separated from each other by moving a slider.

Long cords have been used for transmission of audio signals, for example, from a music reproducing device to headphones or the like. In general, the cords are a pair of cords, consisting of an L-channel (left-channel) cord and an R-channel (right-channel) cord. Besides, a set of three cords is used, which includes a trunk cord connected to the music reproducing device, an L channel-cord, and an R-channel cord.

Since a plurality of cords is included in a cord set, entanglement of the cords is very liable to occur. Since the work of undoing the entangled cords is troublesome, entanglement of cords makes the user unpleasant. In view of this, there has been proposed a parallel cord unit including a first cord body and a second cord body having fitting elements for fitting to each other, and a slider by which the first cord body and the second cord body are gripped.

### SUMMARY

The parallel cord unit described in Japanese Patent Laid-open No. 2007-173089 (hereinafter referred to as Patent Document 1), has a configuration in which with the slider moved, the first cord body and the second cord body are fitted to each other so that they can be handled as if they were a single cord. This makes it possible to restrain the first cord body and the second cord body from getting entangled with each other. At the time of using the parallel cord unit, the slider is moved in the direction opposite to the direction for uniting the cord bodies, whereby the first cord body and the second cord body can be easily separated from each other.

In order to fit together the fitting elements provided respectively in side surfaces of the first cord body and the second cord body, it may be necessary to keep the fitting elements in the state of facing each other. However, the slider described in Patent Document 1 only grips the first cord body and the second cord body, so that it may be impossible to restrain each of the cords from rotating about the axial direction thereof. Therefore, in the case where the cords are entangled with each other or twisted so that the fitting elements are not facing each other, it may be impossible to cause the fitting elements of the first cord body and the second cord body to fit to each other by moving the slider.

Thus, there is a need for a long body unit with slider in which a plurality of long bodies can be united together and separated from each other, in a highly assured manner, by moving a slider.

According to an embodiment of the present technology, there is provided a long body unit with slider, including: a first long body; a second long body; and a slider provided for the first long body and the second long body, the slider including a connection section by which the first long body and the second long body are clamped and are thereby united together, a separation section by which the first long body and the second long body united together by the connection section are separated from each other, and a restriction section by which the first long body and/or the second long body is restricted in rotation about an axial direction.

In accordance with the embodiment of the present technology, the plurality of long bodies can be united with each other and separated from each other in a reliable manner by moving the slider.

### BRIEF DESCRIPTION OF THE DRAWINGS

FIG. 1 illustrates a general configuration of headphones having a long body unit with slider according to a first embodiment of the present technology;

FIGS. 2A and 2B are sectional views showing the configurations of a first cord and a second cord;

FIGS. 3A and 3B are perspective views and FIG. 3C is a horizontal sectional view, which illustrate the configuration of a slider;

FIGS. 4A and 4B illustrate a condition in which the first cord and the second cord are gripped by the slider;

FIGS. 5A to 5E are sectional views illustrating mutual fitting and disengagement of the first cord and the second cord attendant on sliding of the slider;

FIGS. 6A to 6C illustrate a general configuration of band-around-occiput type stereo headphones according to a second embodiment of the present technology;

FIG. 7 is an enlarged view of the vicinity of a headphone unit of the band-around-occiput type stereo headphones;

FIGS. 8A to 8D illustrate a condition in which a head band and a headphone cord are gripped by a slider; and

FIGS. 9A and 9B illustrate a modification of the long body unit and the slider according to an embodiment of the present technology.

### DETAILED DESCRIPTION OF THE PREFERRED EMBODIMENTS

Now, embodiments of the present technology will be described below, referring to the drawings. The description will be made in the following order.

### <1. First Embodiment>

[1-1. Configuration of long body unit with slider]
[1-2. Operation and effect of slider]

### <2. Second Embodiment>

[2-1. Configuration of band-around-occiput type stereo headphones]
[2-2. Operation and effect of slider]

### <3. Modifications>

### 1. First Embodiment

[1-1. Configuration of Long Body Unit with Slider]

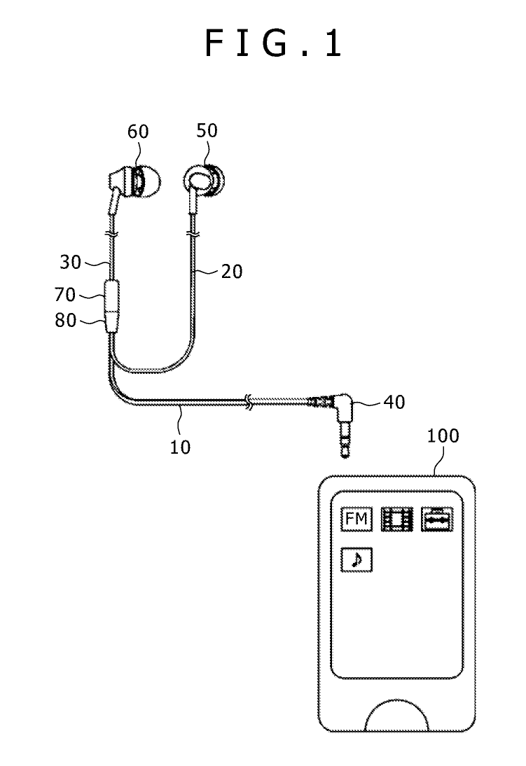

FIG. 1 shows a general configuration of a long body unit with slider according to an embodiment of the present technology. In this embodiment, the long body unit with slider is configured as part of headphones for outputting sounds from a portable-type music reproducing device 100, for example. The headphones include a first cord 10, a second cord 20, a third cord 30, a plug 40, a left-side earphone 50, a right-side earphone 60, a cover 70, and a slider 80.

The first cord 10 has a left-channel conductor L, a right-channel conductor R, and a grounding conductor G passed through the inside thereof, and is a cord for transmission of audio signals outputted from the music reproducing device 100. The first cord 10 corresponds to a first long body in the claims. The plug 40 is provided at one end of the first cord 10, and the headphones are connected to the music reproducing device 100 through the plug 40.

The second cord 20 has a left-channel conductor L and a grounding conductor G passed through the inside thereof, and is a cord for transmission of an audio signal, like the first cord 10. The second cord 20 is formed to be smaller in diametral size (be thinner) than the first cord 10. The second cord 20 corresponds to a second long body in the claims.

The third cord 30 has a right-channel conductor R and a grounding conductor G passed through the inside thereof, and is a cord for transmission of an audio signal. The third cord 30 is formed to be as small in diametral size (as thin) as the second cord 20, which is smaller in diametral size (thinner) than the first cord 10. In addition, the third cord 30 is formed to be shorter than the second cord 20. A right-side earphone 60 is provided at one end of the third cord 30. The third cord 30 corresponds to a third long body in the claims.

The left-channel conductor L and the grounding conductor G in the first code 10 and the left-channel conductor L and the grounding conductor G in the second cord 20 are respectively interconnected by welding, for example. Similarly, the right-channel conductor R and the grounding conductor G in the first cord 10 and the right-channel conductor R and the grounding conductor G in the third cord 30 are respectively interconnected by welding, for example. At the interconnection part, there is provided a cover 70 made of plastic, for example. The interconnection part corresponds to a connection section in the claims. The headphone cord in this embodiment is a so-called U-type cord. The slider 80 is so provided as to grip the first cord 10 and the second cord 20.

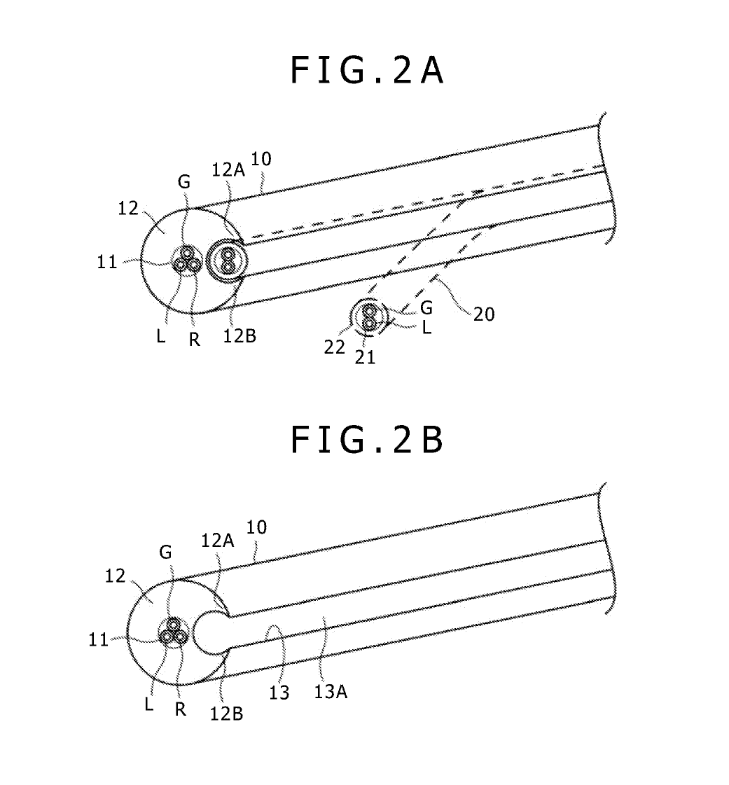

FIGS. 2A and 2B are sectional perspective views showing the configurations of the first cord 10 and the second cord 20. The first cord 10 is a three-core type long cord formed to be roughly circular in sectional shape. The first cord 10 has a first conductor assembly 11 including the left-channel conductor L, the right-channel conductor R, and the grounding conductor G. The first conductor assembly 11 is covered with a first insulator 12 roughly circular in sectional shape. The first insulator 12 is provided at its side surface with a fitting groove 13 along the longitudinal direction thereof. The fitting groove 13 has a roughly circular sectional shape which is smaller in diametral size than the roughly circular sectional shape of the first insulator 12.

The fitting groove 13 is formed to have an opening 13A which opens in a predetermined width in a side surface, along the longitudinal direction of the first insulator 12. The second cord 20 enters through the opening 13A into the fitting groove 13, to be contained there. The width of the opening 13A is set to be smaller than the diameter of the fitting groove 13, whereby a pair of lock sections 12A and 12B are formed to face each other across the opening 13A (to face each other in the direction for closing the opening 13A). The pair of lock sections 12A and 12B is elastic. The second cord 20 contained in the fitting groove 13 are locked by the lock sections 12A and 12B, thereby being held in situ. This prevents the second cord 20 fitted and contained in the fitting groove 13 from being disengaged from the fitting groove 13 in an unguarded manner. The first insulator 12, the fitting groove 13 and the lock sections 12A, 12B are formed from synthetic resin, for example, non-vinyl-chloride resin.

The second cord 20 has a second conductor assembly 21 including the left-channel conductor L and the grounding conductor G. The second conductor assembly 21 is covered with a second insulator 22. The sectional shape of the second insulator 22 is a roughly circular shape, of which the diametral size is substantially the same as the roughly circular sectional shape of the fitting groove 13 so that the second cord 20 can be fitted into the fitting groove 13 in the first cord 10. The second insulator 22 is formed from resin, for example, non-vinyl-chloride resin. With the first cord 10 and the second cord 20 formed not to be roughly tetragonal but to be roughly circular in sectional shape, their areas of contact with an inside surface of a slide body 81 of the slider 80 to be described later are reduced, whereby friction is lessened.

The third cord 30 has a third conductor assembly including the right-channel conductor R and the grounding conductor G, and the third conductor assembly is covered with a third insulator. The third insulator is configured in the same manner as the second insulator 21, except for being shorter in length, and, therefore, description thereof is omitted. Incidentally, each of the first cord 10, the second cord 20 and the third cord 30 may have one or more reinforcement threads (not shown) intermediately provided along the conductor assembly thereof.

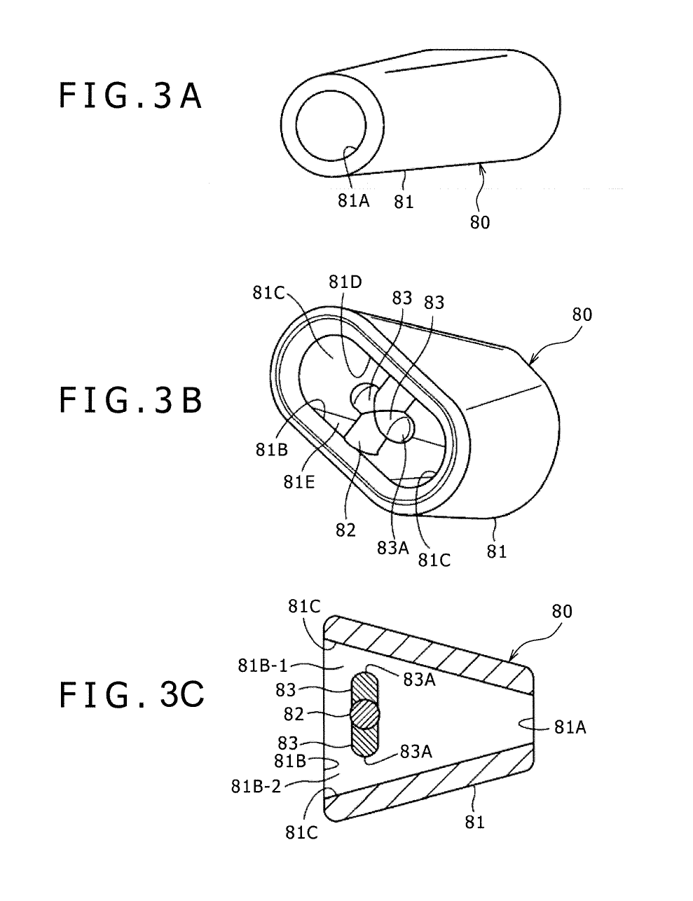

FIGS. 3A to 3C illustrate the configuration of the slider 80. FIG. 3A is a perspective view as viewed from the side of a connection section 81A, FIG. 3B is a perspective view as viewed from the side of a separation port 81B, and FIG. 3C is a horizontal sectional view. The slider 80 has the slider body 81, a separation rib 82, and guide projections 83.

The slider body 81 is formed in a hollow cylindrical shape for slidably gripping the first cord 10 and the second cord 20 therein. The slider body 81 is reduced in aperture diametral size on one end side thereof, to form the connection section 81A. The connection section 81A is designed to pinch and fasten the first cord 10 and the second cord 20 inserted in and passed through the connection section 81A, thereby pressing the second cord 20 into the fitting groove 13 in the first cord 10 so as to unite the first cord 10 and the second cord 20 together.

The connection section 81A is formed to be roughly circular in sectional shape, like the first cord 10. The aperture diametral size of the connection section 81A is approximately equal to or only slightly greater than the diametral size of the first cord 10 so that the second cord 20 can be assuredly fitted into the fitting groove 13 under fastening. This ensures the second cord 20 can be assuredly fitted into the fitting groove 13 by fastening the first cord 10 and the second cord 20, and, simultaneously, the friction between the connection section 81A and the first and second cords 10, 20 coupled together is lessened, so that sliding of the slider 80 is not hampered.

On the other hand, the slider body 81 is horizontally enlarged on the other end side in aperture diametral size, as compared with the connection section 81A, to form a separation port 81B through which the first and second cords 10, 20 separated from each other are led out. Thus, the slider body 81 is formed to be roughly trapezoidal in plan-view shape, narrowed along the direction from the separation port 81B toward the connection section 81A.

Inside side surfaces 81C of the slider body 81 are formed in curved surface shapes such that the first and second cords 10, 20 formed to be roughly circular in section can be slid thereon without being caught. In addition, an inside upper surface 81D and an inside lower surface 81E of the slider body 81 are formed in flat plate shapes.

The separation rib 82 is bridgingly provided between the inside upper surface 81D and the inside lower surface 81E of the slider 81, in a roughly central area in plan view on the side of the separation port 81B of the slider body 81. The separation rib 82 functions as a separation section for separating the first cord 10 and the second cord 20 from each other by being interposed between the first cord 10 and the second cord 20 at a branching part of the first and second cords 10, 20 in the united state.

The separation rib 82 is formed in a roughly cylindrical shape so that the areas of contact thereof with the first and second cords 10, 20 are reduced so as to lessen friction there and to prevent the first and second cords 10, 20 from being caught on the separation rib 82. With the separation rib 82 thus provided, the separation port 81B is partitioned into a first insertion/passage port 81B-1 for insertion/passage of the first cord 10 therein and a second insertion/passage port 81B-2 for insertion/passage of the second cord 20 therein.

The separation rib 82 is provided at its side surfaces with a pair of guide projections 83 projecting respectively into the first insertion/passage port 81B-1 and the second insertion/passage port 81B-2. The guide projection 83 enters into the fitting groove 13 in the first cord 10, thereby to restrict the first cord 10 in rotation about the axial direction so that, inside the slider 80, the opening 13A of the fitting groove 13 is always oriented to face the second cord 20. The guide projection 83 corresponds to a restriction section in the claims.

The lateral width of the guide projection 83 is set to be approximately equal to or only slightly smaller than the opening width of the opening 13A of the fitting groove 13. In addition, the projection width of the guide projection 83 is set to be approximately equal to or only slightly smaller than the depth of the fitting groove 13. This ensures that in the condition where the guide projection 83 has entered into the fitting groove 13, no large gap is formed between the guide projection 83 and the fitting groove 13, so that the first cord 10 is securely restricted in rotation about the axial direction thereof.

Besides, the guide projection 83 has a tip 83A formed in a roughly spherical shape. This prevents the tip 83A of the guide projection 83 from being caught on the inside surface of the fitting groove 13, which is formed in a cylindrical shape. In addition, the second cord 20 is prevented from being caught on the guide projection 83. Consequently, sliding of the slider 80 is not hindered by the guide projections 83.

Incidentally, in this embodiment, the two guide projections 83 are provided to project respectively into the first insertion/passage port 81B-1 and the second insertion/passage port 81B-2. Since the guide projection 83 is destined to enter into the fitting groove 13 in the first cord 10, however, the guide projection 83 may not necessarily provided on the side to project into the second insertion/passage port 81B-2 for insertion/passage of the second cord 20 therein. With the guide projection 83 provided only on the side of the first insertion/passage port 81B-1, the effect of an embodiment of the present technology can be displayed. It is to be noted here, however, that where the guide projections 83 are provided to respectively project into both directions so that the separation rib 82 and the guide projections 83 are both in left-right symmetry, an operation of attaching the separation rib 82 and the guide projections 83 to the slide body 81 in manufacture of the product according to an embodiment of the present technology can be carried out without need to recognize the orientation of the guide projection 83; thus, the manufacture can be carried out speedily and easily. The slide body 81, the separation rib 82, and the guide projections 83 are formed by use of, for example, plastic, polypropylene (PP), polybutylene terephthalate (PBP), metal or the like.

### [1-2. Operation and Effect of Slider]

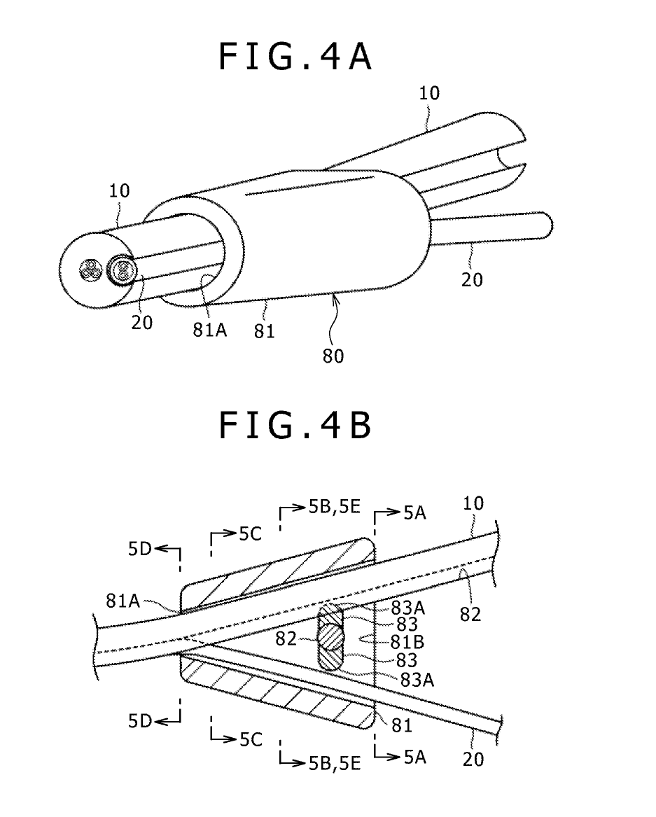

FIGS. 4A and 4B illustrate a condition where the first cord 10 and the second cord 20 are gripped by the slider 80. FIG. 4A is a perspective view, and the FIG. 4B is a horizontal sectional view. On the side of the connection section 81A, the first cord 10 and the second cord 20 are fastened by the connection section 81A, whereby the second cord 20 is fitted into the fitting groove 13 in the first cord 10, to be united with the first cord 10.

On the other hand, on the side of the separation port 81B, the first cord 10 and the second cord 20 are in a separated state. The first cord 10 is being led out through the first insertion/passage port 81B-1, while the second cord 20 is being led out through the second insertion/passage port 81B-2. The separation rib 82 is intermediately present between the first cord 10 and the second cord 20. In addition, as shown in FIG. 4B, the guide projection 83 provided on the separation rib 82 is in the state of having entered into the fitting groove 13 in the first cord 10. This ensures that, for example if the first cord 10 is twisted on the plug 40 side, the first cord 10 is prevented inside the slider 80 from rotating about the axial direction thereof; consequently, the opening 13A of the fitting groove 13 is always oriented to face the second cord 20.

Since the opening 13A of the fitting groove 13 is always oriented to face the second cord 20, nipping and fastening of the first cord 10 and the second cord 20 by the connection section 81A will spontaneously cause the second cord 20 to be pushed into the fitting groove 13. This enables reliable fitting of the second cord 20 into the fitting groove 13.

In the state of being fitted in the fitting groove 13 in the first cord 10, the second cord 20 protrudes from the surface of the first cord 10 only slightly, and is substantially embedded in the first cord 10. Therefore, the first cord 10 and the second cord 20 are united together, and the second cord 20 is embedded in the first cord 10, so that they appear as if only the first cord 10 were present.

When the slider 80 is slid in the direction toward the connection section 81A, the separation rib 82 enters into the branching part of the first and second cords 10 and 20 being in the united state, whereby the first cord 10 and the second cord 20 are separated from each other. After thus separated, the first cord 10 is led out via the first insertion/passage port 81B-1, while the second cord 20 is led out via the second insertion/passage port 81B-2.

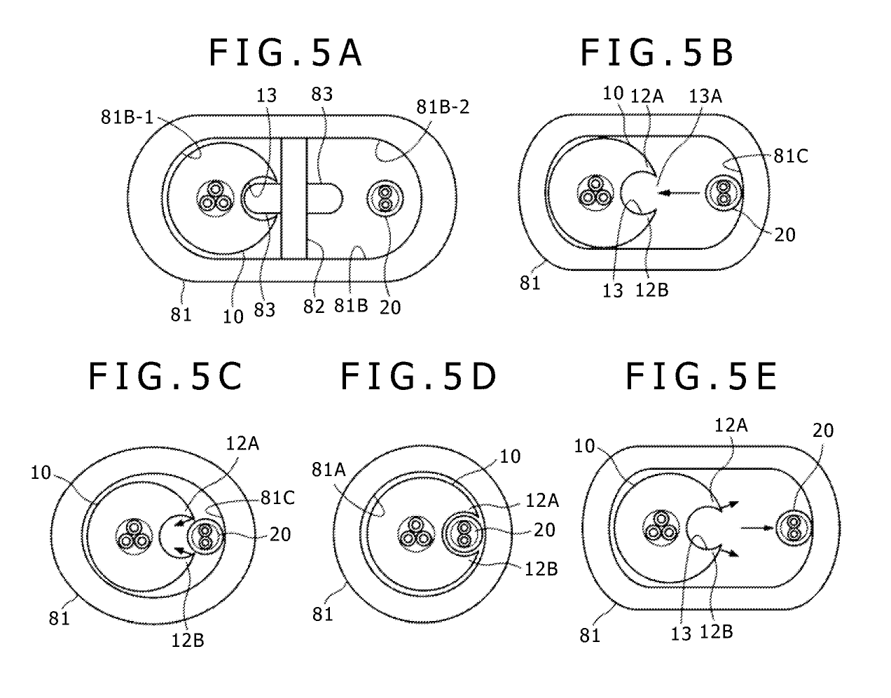

FIGS. 5A to 5E are sectional views illustrating the fitting and disengagement of the first cord 10 and the second cord 20 attendant on sliding of the slider 80. FIG. 5A is a sectional view taken along line 5A-5A of FIG. 4B, FIG. 5B is a sectional view along line 5B-5B of FIG. 4B, FIG. 5C is a sectional view along line 5C-5C of FIG. 4B, FIG. 5D is a sectional view along line 5D-5D of FIG. 4B, and FIG. 5E is a sectional view along line 5E-5E of FIG. 4B.

As shown in FIG. 5A, on the side of the separation port 81B, the first cord 10 and the second cord 20 are separate from each other, and the first cord 10 is being led out through the first insertion/passage port 81B-1, while the second cord 20 is being led out via the second insertion/passage port 81B-2. In addition, the guide projection 83 is in the state of having entered into the fitting groove 13 in the first cord 10, thereby preventing the first cord 10 from rotation about the axial direction thereof, so that the opening 13A of the fitting groove 13 is oriented to face the second cord 20.

In fitting the second cord 20 into the fitting groove 13, the slider 80 is slid in the direction toward the separation port 81B. As a result of this operation, as shown in FIG. 5B, the second cord 20 is pushed toward the first cord 10 by the inside side surface 81C of the slider body 81. When the slider 80 is continually slid further in the direction toward the separation port 81B, as shown in FIG. 5C, the second cord 20 is further pushed toward the first cord 10 due to the gradually decreasing diametral size of the slider body 81.

Then, the opening 13A of the fitting groove 13 formed in the side surface of the first cord 10 and the side surface of the second cord 20 make contact with each other, and the lock sections 12A and 12B are bent in the directions of arrows to the inside of the fitting groove 13 by being pressed by the side surface of the second cord 20. Since the opening 13A of the fitting groove 13 is oriented by the guide projection 83 to face the second cord 20 as has been shown in FIG. 5A, the opening direction of the opening 13A and the position of the second cord 20 are matched to each other without fail, so that the fitting groove 13 and the second cord 20 can be securely faced to each other. Then, as shown in FIG. 5D, the first cord 10 and the second cord 20 are united together.

In the condition where the first cord 10 and the second cord 20 are thus united together, the side surface of the second cord 20 is locked by the lock sections 12A, 12B. Therefore, the second cord 20 is prevented from being disengaged from the fitting groove 13 in an unguardedly. Further, even if the first cord 10 and the second cord 20 in the united state is bent as a whole, the second cord 20 would not be disengaged from the fitting groove 13.

In separating the second cord 20 from the first cord 10, the slider 80 is slid in the direction toward the, connection port 81A opposite to the direction toward the separation port 81B. As a result of this operation, the separation rib 82 intermediately present in the branching part of the first cord 10 and the second cord 20 biases the second cord 20 in a direction for separating away from the first cord 10. Consequently, as shown in FIG. 5E, the elastic lock sections 12A and 12B are bent in the directions of arrows to the outside, whereby the opening 13A is opened wider, so that the second cord 20 is disengaged from the fitting groove 13. Then, as shown in FIG. 5A, the first cord 10 is led out via the first insertion/passage port 81B-1, while the second cord 20 is led out via the second insertion/passage port 81B-2.

Thus, by sliding the slider 80, the first cord 10 and the second cord 20 can be united together or separated from each other at an arbitrary position. This ensures that the position of the branching part of the first cord 10 and the second cord 20 can be freely adjusted. For example, during use of headphones, it is possible, by regulating the length of the second cord 20 to a length fit for the user's taste, to prevent the cord from dangling. In addition, during when the headphones are out of use, it is possible, by moving the slider 80 to the position of reaching the earphone provided at the tip of the second cord 20, to ensure that the first cord 10 and the second cord 20 can be handled as a single cord. This makes it possible to prevent the first cord 10 and the second cord 20 from being entangled with each other.

Incidentally, the configuration in which the separation rib 82 is provided with the guide projections 83 and the guide projection 83 enters into the fitting groove 13 ensures that the fitting groove 13 functions both as a groove for containing the second cord 20 therein and as a groove into which the guide projection 83 enters. This eliminate the need to separately provide a groove for containing the first cord 10 therein and a groove for permitting the guide projection 83 to enter thereinto, so that the first cord 10 can be simplified in configuration.

In general, headphone cords include those of a so-called Y-type structure and those of a so-called U-type structure. The Y-type structure is a headphone cord structure in which a single cord (hereafter referred to as trunk cord) extending from a plug is branched at an intermediately located branching part into a right-ear cord and a left-ear cord, and the right-ear cord and the left-ear cord are the same in length. In the Y-type structure, the right-ear cord and the left-ear cord are formed to extend from the branching part in the direction opposite to the direction in which the trunk cord extends. When the Y-type cord is set in use position, the trunk cord and the right-ear cord and the left-ear cord are in a Y-shaped form as a whole.

On the other hand, the U-type structure is a headphone cord structure in which a trunk cord extending from a plug is branched into a right-ear cord and a left-ear cord, like in the Y-type structure, but the right-ear cord and the left-ear cord are different in length, unlike in the Y-type structure. Besides, either one of the right-ear cord and the left-ear cord extends in the same direction as the trunk cord. In other words, the right-ear cord and the left-ear cord extend in opposite directions. As a result, when the U-type cord is set in use position, the right-ear cord and the left-ear cord are in a U-shaped form as a whole. In the U-type cord structure, a right-ear earphone and a left-ear earphone can be easily distinguished from each other by cord length, which is advantageous. Another advantage of the U-type cord structure resides in that, since the longer one of the right-ear cord and the left-ear cord can be laid around the rear side of the neck, cord dangling in front of the user's body can be obviated.

In the embodiment of the present technology, the second cord 20 is fitted in the fitting groove 13 in the first cord 10 and, therefore, the first cord 10 has to be formed to be greater in diametral size (be thicker) than the second cord 20. In the Y-type cord structure, the right-ear cord and the left-ear cord are branched from the trunk cord to be in a Y-shaped form as a whole, so that it is desirable for the right-ear cord and the left-ear cord to be equal in diametral size (thickness), from the viewpoints of design and balance. Besides, in the Y-type cord structure, the right-ear cord and the left-ear cord are both extended in the direction opposite to the trunk cord. Therefore, it is difficult to realize a structure in which the trunk cord is set large in diameteral size (thickness) and provided with a fitting groove and either of the right-ear cord and the left-ear cord is contained in the trunk cord.

On the other hand, in the U-type cord structure, either one of the right-ear cord and the left-ear cord is extended in the same direction as the trunk cord. Therefore, it is possible, on a structural basis, to contain in the trunk cord the right-ear or left-ear cord extending in the same direction as the trunk cord. This enables a configuration wherein the trunk cord is greater in diametral size (thicker) than the right-ear cord and the left-ear cord, while the right-ear cord and the left-ear cord are equal in diametral size (thickness). Therefore, the long body unit with slider according to this embodiment of the present technology is preferably applied to the U-type cord. Application to the U-type is preferable from the viewpoints of design and balance. FIG. 1 shows the application of the embodiment of the present technology to a U-type cord, wherein the first cord 10 provided with the fitting groove 13 is the trunk cord, and that one of the right-ear cord and the left-ear cord which extends in the same direction as the trunk cord is the second cord.

### 2. Second Embodiment

### [2-1. Configuration of Band-Around-Occiput Type Stereo Headphones]

Now, a second embodiment of the present technology will be described below. In the second embodiment, the first long body is a headband 210, the second long body is a headphone cord 240, and the headband 210 and the headphone cord 240 are united together by use of a slider 80.

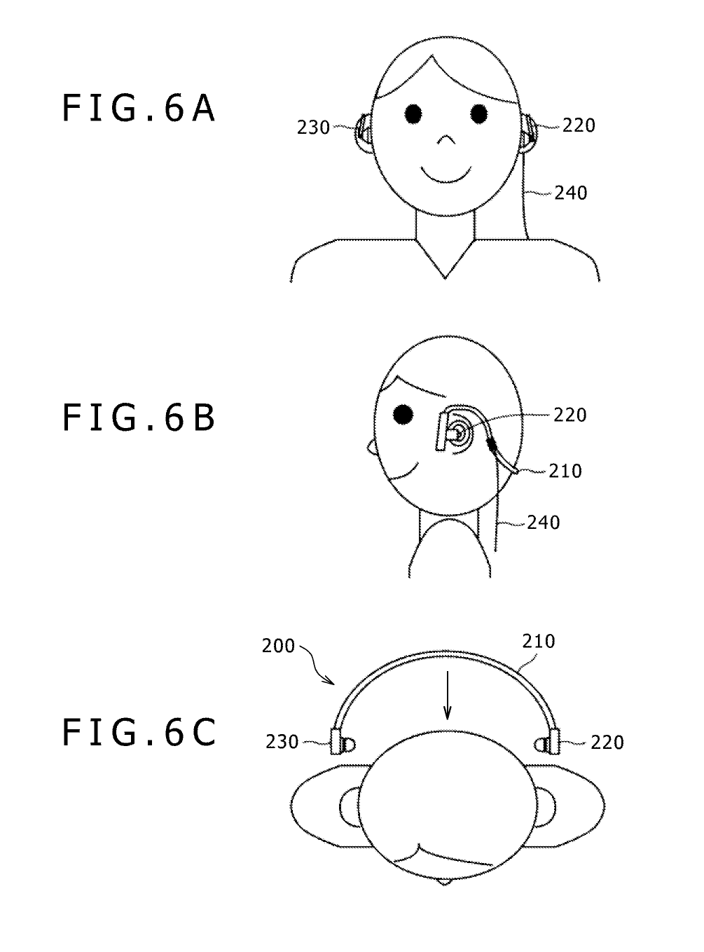

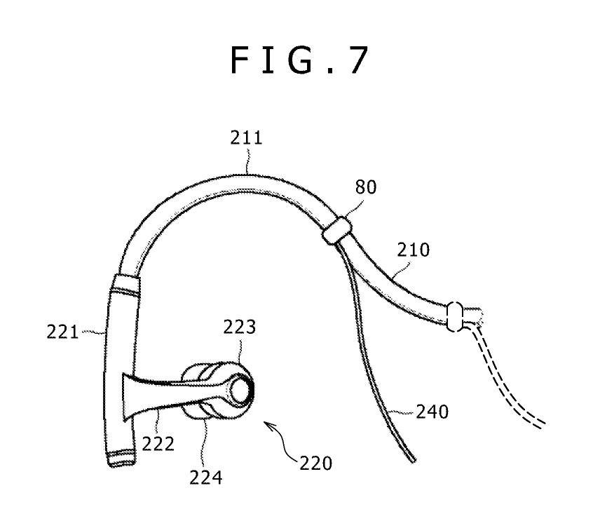

FIGS. 6A to 6C illustrate the general configuration of band-around-occiput type stereo headphones 200 according to the second embodiment, wherein FIG. 6A is a front view, FIG. 6B is a side view, and FIG. 6C is a top plan view. In addition, FIG. 7 is an enlarged view of the vicinity of a left-side headphone unit 220 of the band-around-occiput type stereo headphones 200. The band-around-occiput type stereo headphones 200 include the headband 210, the left-side headphone unit 220 provided at one end of the headband 210, and a right-side headphone unit 230 provided at the other end of the headband 210.

The headband 210 is formed in a curved shape so as to be laid along the shape of the back of the user's head. In addition, the headband 210 has ear hook sections 211 formed in a roughly arched shape for hooking the headband on conchae so that it is held in a condition where its other portion than the ear hook sections 211 is laid along the back of the user's head. A wire (not shown) curved in the shape of the ear hook sections 211 and a shape along the back of the user's head is inserted in the headband 210 so that the shape of the headband 210 will not be easily changed in use.

The headband 210 has a cover body formed by use of an elastic material composed of synthetic resin such as polypropylene (PP), polybutylene terephthalate (PBP), etc.

The left-side headphone unit 220 and the right-side headphone unit 230 are provided respectively at the tips of the left and right ear hook sections 211 of the headband 210. The left-side headphone unit 220 has a hanger 221 having a roughly hollow cylindrical shape, and the hanger 221 and the headband 210 are connected to each other. The hanger 221 is integrally provided with an arm section 222 having a predetermined length and projecting toward the concha so that, when the band-around-occiput type stereo headphones 200 are put in use position, the hanger 221 is located in an erect state in front of the concha.

In addition, a housing 223 is attached to the tip of the arm section 222. Besides, an earpiece 224 constituting a portion to be inserted into the external auditory meatus is attached to the housing 223, with a driver unit (not shown) incorporated therein. Incidentally, the hanger 221 itself is not hooked on the user's concha, and, in practice, the earpiece 224 in the state of being inserted in the user's external auditory meatus holds the ear hook section 211 of the headband 210. The left-side headphone unit 220 is configured in this way. Incidentally, the right-side headphone unit 230 is configured in the same manner, and, therefore, description thereof is omitted.

A headphone cord 240 connected at its one end to a music reproducing device 100 or the like is connected in the manner of extending in parallel to the headband 210. In the headphone cord 240, a conductor assembly including a left-channel conductor L and a right-channel conductor R as well as a grounding conductor G is inserted and passed. The left-channel conductor L and the grounding conductor G in the headphone cord 240 are passed through the hanger 221 and the arm section 222, to be connected to the driver unit in the earpiece 224.

In addition, the right-channel conductor R and the grounding conductor G in the headphone cord 240 are turned back inside the hanger 221, and are connected respectively to a right-channel conductor r and a grounding conductor g in a conductor assembly inserted in the headband 210, for connection to a driver unit for the right channel. This ensures that a right-channel audio signal supplied through the headphone cord 240 can be securely supplied to the right-channel driver unit, irrespectively of the place where the branching point between the headband 210 and the headphone cord 240 is set by the slider 80.

### [2-2. Operation and Effect of Slider]

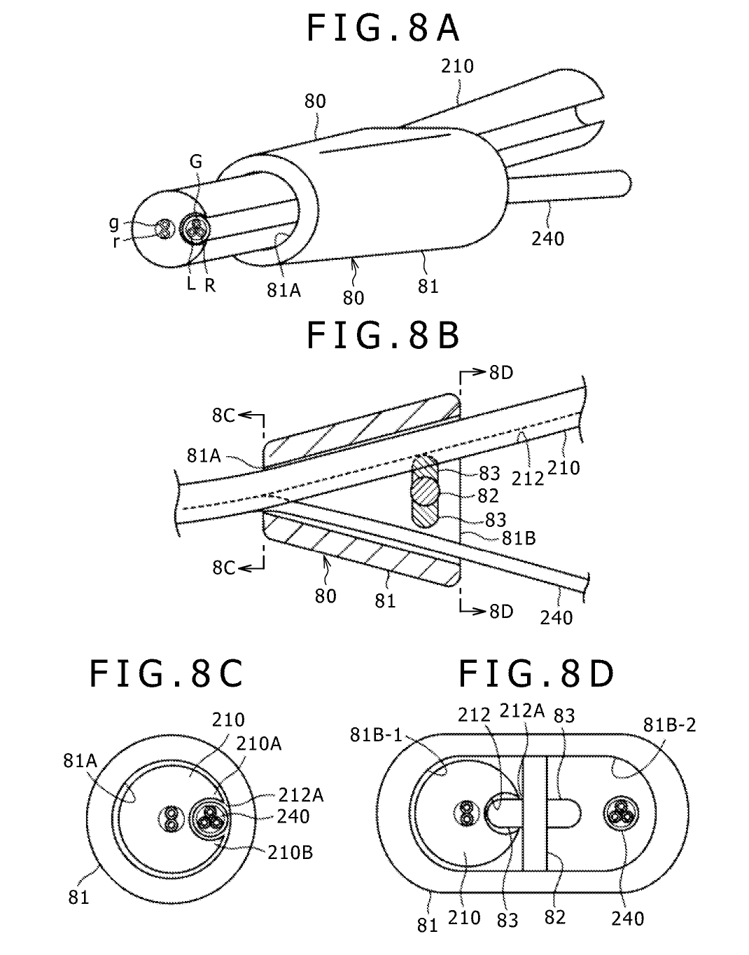

FIGS. 8A to 8D illustrate a condition where the headband 210 and the headphone cord 240 are gripped by the slider 80. FIG. 8A is a perspective view, FIG. 8B is a sectional view, FIG. 8C is a sectional view taken along line 8C-8C of FIG. 8B, and FIG. 8D is a sectional view along line 8D-8D of FIG. 8B.

As shown in FIGS. 8A to 8D, the headphone band 210 is provided along the longitudinal direction thereof with a fitting groove 212 which is roughly circular in sectional shape and has an opening 212A opening in a predetermined width. The fitting groove 212 is configured in the same manner as in the first embodiment above. The headphone cord 240 is fitted into the fitting groove 212 through the opening 212A. The width of the opening 212A is set to be smaller than the diametral size of the fitting groove 212, whereby a pair of lock sections 210A and 210B are formed so as to face each other across the opening 212A (to face each other in the direction for closing the opening 212A). The cord contained in the fitting groove 212 is locked by the lock sections 210A and 210B, thereby being held in situ.

The slider 80 is provided in a slidable manner so as to grip the headband 210 and the headphone cord 240, in order to unite the headband 210 and the headphone cord 240 together. The slider 80 is configured in the same manner as in the first embodiment above. In the second embodiment, the slider 80 is configured to have an inside diametral size approximately equal to or slightly greater than the diametral size of the headband 210.

As shown in FIG. 8C, on the side of a connection section 81A, the headband 210 and the headphone cord 240 are fastened by the connection section 81A, whereby the headphone cord 240 is fitted into the fitting groove 212 in the headband 210, to be united with the headband 210. On the other hand, as shown in FIG. 8D, on the side of a separation port 81B, the headband 210 and the headphone cord 240 are in a separate state, and a separation rib 82 is intermediately present between the headband 210 and the headphone cord 240. In addition, as shown in FIGS. 8B and 8D, one of guide projections 83 possessed by the separation rib 82 is in the state of having entered into the fitting groove 212 in the headband 210. This ensures that when the headband 210 enters the slider 80, the headband 210 is so restricted that the opening 212A of the fitting groove 212 is always oriented to face the headphone cord 240.

Since the opening 212A of the fitting groove 212 is always oriented to face the headphone cord 240, nipping and fastening of the headband 210 and the headphone cord 240 by the connection section 81A will spontaneously cause the headphone cord 240 to be pushed into the fitting groove 212. This enables reliable fitting of the headphone cord 240 into the fitting groove 212.

When the headphone cord 240 is fitted in the fitting groove 212, the side surface of the headphone cord 240 protrudes from the surface of the headband 210 only slightly, and the headphone cord 240 is substantially embedded in the headband 210. Therefore, the headband 210 and the headphone cord 240 are united together, so that they appear as if only the headband 210 is present.

When the slider 80 is slid in the direction toward the connection section 81A, the separation rib 82 enters into the branching part of the headband 210 and the headphone cord 240 being in the united state, whereby the headband 210 and the headphone cord 240 are separated from each other.

Thus, in the second embodiment, by moving the slider 80, the headband 210 and the headphone cord 240 can be separated from each other or united together at an arbitrary position. This ensures that during use of the band-around-occiput type stereo headphones 200, the position of the branching part of the headband 210 and the headphone cord 240 can be freely adjusted, and the headphone cord 240 can thereby be prevented from dangling. In addition, when the band-around-occiput type stereo headphones 200 are out of use, the headband 210 and the headphone cord 240 can be united together and can be handled as a single band. This makes it possible to prevent the headband 210 and the headphone cord 240 from being entangled with each other.

Incidentally, in the second embodiment, description has been made while taking as an example the case where an embodiment of the present technology is applied to a headband 210 to be laid around the back of the user's head. However, this is not limitative. An embodiment of the present technology can similarly be applied to a headband to be laid on top of the user's head, or a headband to be laid under the user's chin.

Further, in this embodiment as above, description has been made of the case where an elastic material composed of synthetic resin such as polypropylene (PP), polybutylene terephthalate (PBP), etc. is used as the material for the cover body constituting the headphone band 210. However, this is not limitative. Not only the elastic materials composed of synthetic resin but also metallic materials having corrosion resistance and materials being elastic notwithstanding being metallic can be used to form the headband 210.

### 3. Modifications

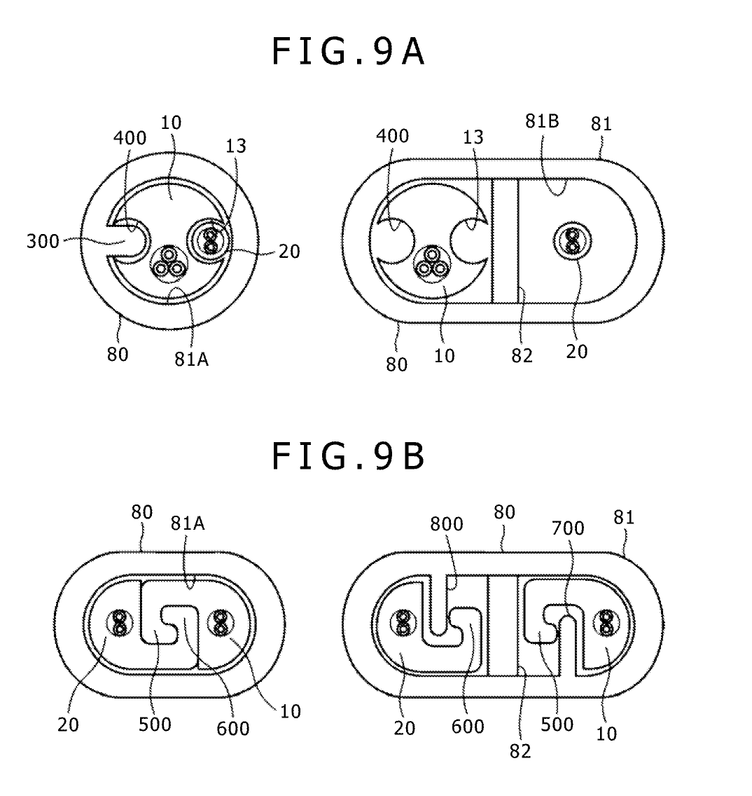

While some embodiments of the present technology have been specifically described above, the technology is not limited to the above embodiments, and various modifications based on the technical thought of the technology are possible. For instance, in the above embodiments, the guide projections 83 have been provided at side surfaces of the separation rib 82 located on the side of the separation port 81B of the slider body 81. However, the positions where to provide the guide projections 83 are not limited to the separation rib 82. For example, as shown in FIG. 9A, a guide projection 300 may be provided on the side of the connection section 81A of the slider body 81. Incidentally, in that case, the guide projection 300 cannot be made to enter into the fitting groove 13, and, therefore, the first cord 10 has to be provided with a guide projection groove 400 into which the guide projection 300 is permitted to enter. In the first cord 10 shown in FIG. 9A, the guide projection groove 400 comparable in diameter to the fitting groove 13 is formed along the longitudinal direction in a side surface on the side opposite to the fitting groove 13. When such a configuration is adopted, also, it is possible to restrict the first cord 10 in rotation about the axial direction and thereby to ensure that the opening direction of the fitting groove 13 is always oriented to face the second cord 20.

Besides, in the above embodiments, the first cord 10 has been provided with the fitting groove 13, and the second cord 20 has been fitted into the fitting groove 13, thereby uniting the first cord 10 and the second cord 20 together. However, the configuration for uniting the first cord 10 and the second cord 20 together is not limited to such a configuration. For example, as shown in FIG. 9B, the first cord 10 and the second cord 20 may be provided respectively with engagement pieces 500 and 600 which can be engaged with each other. In addition, the slider body 81 is provided with guide projections 700 and 800 corresponding respectively to the engagement piece 500 of the first cord 10 and the engagement piece 600 of the second cord 20. With the first cord 10 and the second cord 20 fastened by a connection section 81A, the engagement piece 500 and the engagement piece 600 are engaged with each other, whereby the first cord 10 and the second cord 20 can be united together. In this configuration, the first cord 10 and the second cord 20 can be made approximately equal in diametral size (thickness); therefore, this configuration can be applied to a Y-type cord, without giving the user an uncomfortable feeling from the viewpoints of design and balance.

In addition, while description has been made in the above embodiments by taking as an example the case where the present technology is applied to a earphone or headphone cord, the technology can be applied to any system in which a plurality of long bodies are used in a set, such as speaker cords.

The present disclosure contains subject matter related to that disclosed in Japanese Priority Patent Application JP 2010-184357 filed in the Japan Patent Office on Aug. 19, 2010, the entire content of which is hereby incorporated by reference.

What is claimed is:

1. A long body unit with slider, comprising:
a first long body;
a second long body; and
a slider provided for the first long body and the second long body, the slider including,
a connection section by which the first long body and the second long body are clamped and are thereby united together,
a separation section by which the first long body and the second long body united together by the connection section are separated from each other, and
a restriction section by which the first long body and/or the second long body is restricted in rotation about an axial direction.

2. The long body unit with slider according to claim 1, wherein,
the first long body is provided in its side surface with a fitting groove along a longitudinal direction thereof,
the second long body is formed to be smaller in diametral size than the first long body so as to be fitted in the fitting groove, and
the slider is slid along the first long body and the second long body, whereby the connection section fits the second long body into the fitting groove to unite the first body and the second body together.

3. The long body unit with slider according to claim 2, wherein the restriction section is a projection which enters into the fitting groove so as to restrict the first long body in rotation about the axial direction, whereby an opening direction of the fitting groove is restricted to a direction for facing the second long body.

4. The long body unit with slider according to claim 3, wherein the restriction section is formed to have a width approximately equal to an opening width of the fitting groove.

5. The long body unit with slider according to claim 3, wherein the restriction section has a tip formed in a spherical shape.

6. The long body unit with slider according to claim 2, wherein,
the first long body is formed to be roughly circular or roughly elliptical in overall sectional shape,
the fitting groove is formed to be roughly circular or roughly elliptical in sectional shape, and
the second long body is formed to be roughly circular or roughly elliptical in sectional shape so as to be fittable in the fitting groove.

7. The long body unit with slider according to claim 1, wherein the first long body and the second long body are cords.

8. The long body unit with slider according to claim 1, wherein the first long body is a band, and the second long body is a cord.

9. The long body unit with slider according to claim 2, further comprising:
a third long body which is shorter than the second long body and is formed to be roughly as small as the second long body in diametral size; and
a connection section by which the first long body and the second long body and the third long body are connected together on one end side,
wherein the first long body and the second long body extend from the one end side of the connection section, whereas the third long body extends from the other end side of the connection section.
